(19) United States
(12) Patent Application Publication
(10) Pub. No.: US 2007/0219315 A1
(43) Pub. Date: Sep. 20, 2007

(54) Novel Concentrated Inverse Latex, Production Method, and use Thereof in Industry

(76) Inventor: Olivier Braun, Castres (FR)

Correspondence Address: YOUNG & THOMPSON, 745 SOUTH 23RD STREET, 2ND FLOOR, ARLINGTON, VA, 22202, US

(21) Appl. No.: 10/576,736

(22) PCT Filed: Oct. 7, 2004
(86) PCT No.: PCT/FR04/50492

§ 371 Date: Nov. 10, 2006

(30) Foreign Application Priority Data
Oct. 22, 2003 (FR) 0350717

(51) Int. Cl. C08F 2/32

(52) U.S. Cl. 524/801

(57) ABSTRACT

The invention relates to an inverse latex composition comprising: a) 50 to 80 weight % of at least one linear, branched or cross-linked organic polymer (P), b) 5 to 10 weight % of an emulsifier system (S1) of the water-in-oil (W/O) type, c) 5 to 45 weight % of at least one oil and d) 0 to 5 weight % of water. Said invention also relates to the preparation method and use thereof.

The present patent application relates to thickening water-in-oil inverse latexes, to their process of preparation and to their application as thickener and/or emulsifier in industrial products, in care products for the skin and hair or for the manufacture of cosmetic, dermopharmaceutical or pharmaceutical preparations.

Inverse latexes of polymers of partially or completely salified 2-methyl-2-[(1-oxo-2-propenyl)amino]-1-propane-sulfonic acid (also known as 2-acrylamido-2-methyl-propanesulfonic acid, ATBS or AMPS) and their use in cosmetics and/or pharmaceuticals have formed the subject of numerous patent applications. However, the presence of large amounts of water and oil represents a not insignificant disadvantage in terms of volume, of cost and sometimes of increased risk and/or of toxic effects.

Solutions have thus been developed in order to increase the concentration of polymers in the final latexes, for example by subjecting the reaction medium at the end of the polymerization to a vacuum distillation stage in order to remove a more or less large portion of water and oil. However, this distillation is problematic to carry out as it often destabilizes the reverse latex, which destabilization has to be countered by the prior addition of stabilizing agents. European patent applications EP 0 161 038 and EP 0 126 528 and British patent application GB 1 482 515 disclose such a use of stabilizing polymers.

However, these comprise alcohols or glycols which produce environmental problems. Furthermore, the reaction medium sometimes sets solid during the distillation stage without this phenomenon really ever having been explained but having the certain consequence of the loss of the batch of reverse latex and laborious and expensive cleaning of the reactor. Finally, even when the distillation takes place correctly, the reverse latexes obtained often invert with difficulty, they have a high viscosity and sometimes internally exhibit microgels. These disadvantages thus forbid them from being used in the manufacture of cosmetic formulations and/or textile printing formulations.

For these reasons, the Applicant Company has endeavored to develop concentrated inverse latexes, that is to say comprising at least 50% by weight of polymer and less than 5% by weight of water, which are devoid of such disadvantages.

According to a first aspect, a subject matter of the invention is a composition in the form of an inverse latex comprising:
a) from 50% by weight to 80% by weight of at least one linear, branched or crosslinked organic polymer (P),
b) from 5% by weight to 10% by weight of an emulsifying system (S₁) of water-in-oil (W/O) type,
c) from 5% by weight to 45% by weight of at least one oil, and
d) from 0% to 5% by weight of water.

The polymer (P) present in the composition which is a subject matter of the invention can be a homopolymer or a polymer formed from several different types of monomers. It is mainly a copolymer, a terpolymer or a tetrapolymer.

The composition as defined above comprises either a single polymer (P) or a blend of different polymers (P).

According to a first specific aspect of the present invention, the polymer (P) is
either a homopolymer of a monomer chosen either from those having a partially or completely salified strong acid functional group or from those having a partially or completely salified weak acid functional group or from cationic monomers,
or a copolymer in which each of the monomers is chosen, independently of one another, either from those having a partially or completely salified strong acid functional group or from those having a partially or completely salified weak acid functional group or from neutral monomers or from cationic monomers,
or a terpolymer in which each of the monomers is chosen, independently of one another, either from those having a partially or completely salified strong acid functional group or from those having a partially or completely salified weak acid functional group or from neutral monomers or from cationic monomers,
or a tetrapolymer in which each of the monomers is chosen, independently of one another, either from those having a partially or completely salified strong acid functional group or from those having a partially or completely salified weak acid functional group or from neutral monomers or from cationic monomers.

In the composition as defined above, the emulsifying system (S₁) of water-in-oil (W/O) type is composed either of a single surfactant or of a mixture of surfactants, provided that said mixture has an HLB value which is sufficiently low to bring about water-in-oil emulsions. Examples of emulsifying agent of water-in-oil type include sorbitan esters, such as sorbitan oleate, such as that sold by Seppic under the name Montane™ 80, sorbitan isostearate, such as that sold by Seppic under the name Montane™ 70, or sorbitan sesquioleate, such as that sold by Seppic under the name Montane™ 83. Additional emulsifying agents of water-in-oil type are some polyethoxylated sorbitan esters, for example pentaethoxylated sorbitan monooleate, such as that sold by Seppic under the name Montanox™ 81, or pentaethoxylated sorbitan isostearate, such as that sold under the name Montanox™ 71 by Seppic. Further emulsifying agents of water-in-oil type are diethoxylated oleocetyl alcohol, such as that sold under the name Simulsol™ OC 72 by Seppic, tetraethoxylated lauryl acrylate, such as that sold under the name Blemmer™ ALE 200, or polyesters with a molecular weight of between 1000 and 3000 produced from the condensation between a poly(isobutenylsuccinic acid) or its anhydride and a polyethylene glycol, such as Hypermer™ 2296, sold by Unichema, or, finally, block copolymers with a molecular weight of between 2500 and 3500, such as Hypermer™ B246, sold by Unichema, or Simaline™ IE 200, sold by Seppic.

The term “branched polymer” denotes, for (P), a nonlinear polymer which has pendent chains so as to obtain, when this polymer is dissolved in water, a high state of entanglement resulting in very high viscosities at low gradient.

The term “crosslinked polymer” denotes, for (P), a nonlinear polymer existing in the form of a three-dimensional network which is insoluble in water but which is swellable in water and which thus results in a chemical gel being obtained.

The composition according to the invention can comprise linear units, crosslinked units and/or branched units.

When the polymer (P) is crosslinked, it is crosslinked more particularly with a diethylene or polyethylene compound in the molar proportion, expressed with respect to the monomers employed, of 0.005% to 1%, preferably of 0.01% to 0.2% and more particularly of 0.01% to 0.1%. Preferably, the crosslinking agent and/or the branching agent is chosen from ethylene glycol dimethacrylate, diethylene glycol diacrylate, sodium diallyloxyacetate, ethylene glycol diacrylate, diallylurea, triallylamine, trimethylolpropane tri-acrylate or methylenebis(acrylamide).

The strong acid functional group of the monomers comprising it is in particular the sulfonic acid functional group or the phosphonic acid functional group. Said monomers are, for example, partially or completely salified styrenesulfonic acid or, preferably, partially or completely salified 2-methyl-2-[(1-oxo-2-propenyl)amino]-1-propanesulfonic acid (also known as 2-acrylamido-2-methylpropanesulfonic acid).

The weak acid functional group of the monomers comprising it is in particular the partially salified carboxylic acid functional group. Said monomers can, for example, be partially or completely salified acrylic acid, methacrylic acid, itaconic acid, maleic acid or 3-methyl-3-[(1-oxo-2-propenyl)amino]butanoic acid.

The neutral monomers are chosen in particular from acrylamide, methacrylamide, diacetone acrylamide, dimethylacrylamide, N-isopropylacrylamide, N-[2-hydroxy-1,1-bis(hydroxymethyl)ethyl]propenamide [or tris (hydroxymethyl) acrylamidomethane or N-[tris (hydr-oxymethyl)methyl]acrylamide, also known as THAM], 2-hydroxyethyl acrylate, 2,3-dihydroxypropyl acrylate, 2-hydroxyethyl methacrylate, 2,3-dihydroxypropyl methacrylate, an ethoxylated derivative with a molecular weight of between 400 and 1000 of each of these esters, or vinylpyrrolidone.

The cationic monomers are chosen in particular from quaternary ammonium derivatives. Said monomers can, for example, be 2,N,N,N-tetramethyl-2-[(1-oxo-2-propenyl)amino]propanammonium, 2,N,N-trimethyl-2-[(1-oxo-2-propenyl)amino]propanammonium, N,N,N-trimethyl-2-[(1-oxo-2-propenyl)oxy]ethanammonium, N,N,N-trimethyl-3-[(1-oxo-2-propenyl)oxy]propanammonium, N,N,N-trimethyl-2-[(1-oxo-2-propenyl)amino]propanammonium or diallyl-dimethylammonium salts. The term “salt” is understood to mean more particularly the chlorides, the bromides or the iodides of said ammonium salts.

For the monomers comprising a strong acid functional group or comprising a weak acid functional group, the term “salified” means the alkali metal salts, such as the sodium or potassium salts, or the salts of nitrogenous bases, such as the ammonium salt or the monoethanolamine (HO—CH₂—CH₂—NH₄⁺) salt.

According to a second specific aspect of the present invention, the polymer (P) is chosen from:
crosslinked copolymers of acrylic acid, partially salified in the sodium salt or ammonium salt form, and of acrylamide;
crosslinked copolymers of 2-methyl-2-[(1-oxo-2-propenyl)amino]-1-propanesulfonic acid, partially salified in the sodium salt form, and of acrylamide;
crosslinked copolymers of 2-methyl-2-[(1-oxo-2-propenyl)amino]-1-propanesulfonic acid and of acrylic acid, which are partially salified in the sodium salt form;
crosslinked copolymers of 2-methyl-2-[(1-oxo-2-propenyl)amino]-1-propanesulfonic acid, partially salified in the sodium salt form, and of 2-hydroxyethyl acrylate;
crosslinked copolymers of acrylamide and of N,N,N-trimethyl-3-(1-oxo-2-propenyl)propanammonium;
crosslinked homopolymers of 2-methyl-2-[(1-oxo-2-propenyl)amino]-1-propanesulfonic acid, partially salified in the sodium salt form;
crosslinked homopolymers of acrylic acid, partially salified in the ammonium salt or monoethanolamine salt form;
terpolymers of acrylamide, of N,N,N-trimethyl-3-(1-oxo-2-propenyl)propanammonium and of [tris(hydroxymethyl)aminomethyl]acrylamide;
crosslinked terpolymers of acrylamide, of 2-methyl-2-[(1-oxo-2-propenyl)amino]-1-propane-sulfonic acid and of acrylic acid, which are partially salified in the sodium salt form;
terpolymers of 2-methyl-2-[(1-oxo-2-propenyl)-amino]-1-propanesulfonic acid, partially salified in the sodium salt form, of acrylamide and of vinylpyrrolidone.

According to a third specific form of the present invention, the composition as defined above comprises at least 60% by weight and at most 70% by weight of polymer (P).

According to a fourth specific form of the present invention, the composition as defined above additionally comprises up to 5% of its weight of an emulsifying system (S₂) of oil-in-water (O/W) type.

The term “emulsifying agent of oil-in-water type” denotes emulsifying agents having an HLB value which is sufficiently high to provide oil-in-water emulsions, such as ethoxylated sorbitan esters, for example the sorbitan oleate polyethoxylated with 20 mol of ethylene oxide sold by Seppic under the name of Montanox™ 80, the sorbitan laurate polyethoxylated with 20 mol of ethylene oxide sold by Seppic under the name of Montanox™ 20, the castor oil polyethoxylated with 40 mol of ethylene oxide sold under the name of Simulsol™ OL50, the decaethoxylated oleodecyl alcohol sold by Seppic under the name of Simulsol™ OC 710, the heptaethoxylated lauryl alcohol sold under the name of Simulsol™ P7, the decaethoxylated nonylphenol sold under the name of Synperonic™ NP-10 or the polyethoxylated sorbitan hexaoleates sold by Atlas under the names of G-1086 and G-1096.

In the composition which is a subject matter of the present invention, the oil phase is composed either of a commercial mineral oil comprising saturated hydrocarbons, such as paraffins, isoparaffins or cycloparaffins, and exhibiting, at ambient temperature, a density between 0.7 and 0.9 and a boiling point of greater than approximately 250° C., such as, for example, Marcol™52, sold by Exxon Chemical, or of a vegetable oil, such as squalane of vegetable origin, or of a synthetic oil, such as hydrogenated polyisobutene or hydrogenated polydecene, or of a mixture of several of these oils. Marcol™ 52 is a commercial oil corresponding to the definition of liquid paraffins of the French Pharmacopeia. It is a white mineral oil in accordance with the FDA 21 CFR 172.878 and CFR 178.3620 (a) regulations and is included in the United States Pharmacopeia, US XXIII (1995), and in the European Pharmacopeia (1993). The composition according to the invention can also comprise various additives, such as complexing agents, chain transfer agents or chain-limiting agents.

According to another aspect of the present invention, a subject matter of the latter is a process for the preparation of the composition as defined above, characterized in that:
a) an aqueous phase (A) comprising the monomers and the optional hydrophilic additives is emulsified in an organic phase (O) comprising the surfactant system (S₁), a mixture composed of the oil intended to be present in the final composition and of a volatile oil, and the optional hydrophobic additives,
b) the polymerization reaction is initiated by introduction of an initiator of free radicals into the emulsion formed in a) and then the reaction is allowed to take place, and
c) the reaction medium resulting from stage b) is concentrated by distillation until said volatile oil has been completely removed.

The volatile oils appropriate for the implementation of the process as defined above are, for example, light isoparaffins comprising from 8 to 11 carbon atoms, such as, for example, those sold under the names of Isopar™ G, Isopar™ L, Isopar™ H or Isopar™ J.

According to a preferred implementation of the process as defined above, the polymerization reaction is initiated by an oxidation/reduction couple, such as the cumene hydroperoxide/sodium metabisulfite couple, at a temperature of less than or equal to 10° C., and is then carried out either quasiadiabatically up to a temperature of greater than or equal to 40° C., more particularly of greater than or equal to 50° C., or by controlling the change in the temperature.

When stage c) is complete, one or more emulsifying agents of oil-in-water type are introduced, if desired, at a temperature of less than 50° C.

Another subject matter of the invention is the use of the composition as defined above in preparing a cosmetic, dermopharmaceutical or pharmaceutical topical composition.

A topical composition according to the invention, intended to be applied to the skin or mucous membranes of man or animals, can consist of a topical emulsion comprising at least one aqueous phase and at least one oil phase. This topical emulsion can be of the oil-in-water type. More particularly, this topical emulsion can consist of a fluid emulsion, such as a milk or a fluid gel. The oil phase of the topical emulsion can consist of a mixture of one or more oils.

A topical composition according to the invention may be intended for a cosmetic use or may be used to prepare a medicament intended for the treatment of diseases of the skin and mucous membranes. In the latter case, the topical composition then comprises an active principle which can, for example, consist of an antiinflammatory agent, a muscle relaxant, an antifungal or antibacterial.

When the topical composition is used as cosmetic composition intended to be applied to the skin or mucous membranes, it may or may not comprise an active principle, for example a moisturizing agent, a tanning agent, a sunscreen, an agent for combating wrinkles, an agent with a slimming purpose, an agent for combating free radicals, an antiacne agent or antifungal.

A topical composition according to the invention usually comprises between 0.1% and 10% by weight of the thickening agent defined above. The pH of the topical composition is preferably greater than or equal to 5.

The topical composition can additionally comprise compounds conventionally present in compositions of this type, for example fragrances, preservatives, colorants, emollients or surfactants.

According to yet another aspect, the invention relates to the use of the novel thickening agent in accordance with the invention mentioned above for thickening and emulsifying a topical composition comprising at least one aqueous phase.

The composition according to the invention is an advantageous substitute for those sold under the names of Sepigel™ 305, Sepigel™ 501, Simulgel™ EG, Simulgel™ NS or Simulgel™ 600 by the Applicant Company as it is also very compatible with the other excipients used in the preparation of formulations such as milks, lotions, creams, salts, baths, balms, shampoos or conditioners. They can also be employed with said Sepigel or Simulgel products.

It is in particular compatible with the concentrates disclosed and claimed in international publications WO 92/06778, WO 95/04592, WO 95/13863, WO 96/37285, WO 98/22207 or WO 98/47610 or in FR 2734 496 and with the surface-active agents disclosed in WO 93/08204.

It is particularly compatible with Montanov™ 68, Montanov™ 82, Montanov™ 202 or Sepiperl™ N. It can also be used in emulsions of the type of those disclosed and claimed in EP 0 629 396 and in the aqueous dispersions which are cosmetically or physiologically acceptable with an organopolysiloxane compound chosen, for example, from those disclosed in WO 93/05762 or in WO 93/21316.

It can also be used to form cosmetically or physiologically acceptable aqueous gels at acidic pH, such as those disclosed in WO 93/07856; it can also be used in combination with nonionic celluloses, for example to form styling gels, such as those disclosed in EP 0 684 024, or also in combination with esters of fatty acids and of sugar, to form compositions for the treatment of the hair or the skin, such as those disclosed in EP 0 603 019, or also in shampoos or conditioners, such as disclosed and claimed in WO 92/21316, or, finally, in combination with an anionic homopolymer, such as Carbopol™, to form hair treatment products, such as those disclosed in DE 195 23596, or in combination with other thickening polymers. 6p The composition according to the invention is also compatible with the active principles, such as, for example, self-tanning agents, such as dihydroxyacetone (DHA), or antiacne agents; they can thus be introduced into self-tanning compositions, such as those claimed in EP 0 715 845, EP 0 604 249, EP 0 576 188 or in WO 93/07902.

It is also compatible with the N-acylated derivatives of amino acids, which allows it to be used in soothing compositions, in particular for sensitive skin, such as those disclosed or claimed in WO 92/21318, WO 94/27561 or in WO 98/09611.

When the composition as defined above is intended for the treatment of the hair, it more particularly comprises an inverse latex of cationic polymer which is a subject matter of the present invention.

When the composition as defined above is intended for the treatment of the skin and/or mucous membranes, it more particularly comprises an inverse latex of anionic polymer which is a subject matter of the present invention.

The inverse latexes which are a subject matter of the present invention can be used as thickeners for textile printing pastes.

The aim of the following examples is to illustrate the present invention.

### EXAMPLE 1

### Inverse Latex of the AM/APTAC/THAM Terpolymer (Molar Ratio of Monomers: 73/20/7) (Cationic Thickener—Composition 1)

a) The following are successively introduced, with stirring, into a first beaker:
388.8 g of a commercial 50% by weight acrylamide (AM) solution
206.5 g of a commercial 75% N,N,N-trimethyl-3-[(1-oxo-2-propenyl)propanammonium chloride (APTAC) solution
46 g of [tris(hydroxymethyl)aminomethyl]acrylamide (THAM)
0.56 g of commercial 40% sodium diethylene-triaminepentaacetate solution, and
deionized water, so as to bring the total weight to 813.8 g
The pH is adjusted to 5.

b) An organic phase is prepared in a second beaker by mixing:
137.5 g of Marcol™ 52
186.3 g of Isopar™ G
25 g of Montane™ 70 (sorbitan isostearate)
6.2 g of Hypermer™ 2296
6.0 g of Simaline™ IE 200
6.2 g of tetraethoxylated lauryl acrylate,
125 g of azobis(isobutyronitrile) (AIBN)

c) The two phases are subsequently mixed with stirring and subjected to vigorous mechanical stirring so as to create a fine emulsion. This emulsion is subsequently placed in a reactor and nitrogen is sparged therein in order to remove the dissolved oxygen therefrom.

d) After cooling to approximately 8° C., the polymerization reaction is initiated using the oxidation/reduction couple: cumene hydroperoxide/sodium metabisulfite.

e) Once the polymerization reaction is complete, the Isopar™ G and virtually all the water are removed by vacuum distillation.

f) After introduction of 5% of Montanox™ 20, a cationic thickening inverse latex is obtained which comprises approximately 63% of polymer. The product obtained is devoid of particles and of microgel. It is not very viscous, it has a high thickening power and it readily inverts. Its water content, measured by Karl-Fischer titrimetry, is 3% by weight.

Viscosity measurements (Brookfield RVT viscometer)

| | Spindle (S); Speed of | |
|---|---|---|
| | rotation of the | |
| | spindle (SR) (in | |
| | revolutions per | Viscosity in |
| | minute) | mPa · s |
| Inverse latex | S 4; SR: 20 | 6000 |
| 2% by weight | S 6; SR: 5 | 139 000 |
| aqueous solution | | |
| 2% by weight | S 6; SR: 5 | 12 900 |
| aqueous solution + | | |
| 0.1% by weight | | |
| of NaCl | | |

### EXAMPLE 2

### Inverse Latex of the AM/ATBS Copolymer (Molar Ratio: 70/30) Crosslinked with MBA (Anionic Thickener—Composition 2)

a) The following are successively introduced, with stirring, into a first reactor:
245 kg of a commercial 50% by weight acrylamide (AM) solution
308.1 kg of a commercial solution comprising 55% of the sodium salt of 2-acrylamido-2-methylpropanesulfonic acid (ATBS)
0.066 kg of methylenebis(acrylamide) (MBA)
0.37 kg of a commercial 40% sodium diethylene-triaminepentaacetate solution
the pH is adjusted to 5.0 using powdered 2-acrylamido-2-methylpropanesulfonic acid
deionized water, so as to bring the total weight to 564.3 kg.

b) An organic phase is prepared in a second reactor by mixing:
107.6 kg of polyisobutene
74.5 kg of Isopar™ G
14.1 kg of Montane™ 70
2.5 kg of Hypermer™ 2296
4.1 kg of Simaline™ IE 200

c) The aqueous phase is then introduced into the organic phase with stirring and then the pre-emulsion thus obtained is subjected to vigorous mechanical stirring using a turbine mixer of Silverson type so as to create a fine emulsion while sparging with nitrogen.

d) After cooling to approximately 8° C., the polymerization reaction is initiated using the oxidation/reduction couple: ammonium persulfate/sodium metabisulfite.

e) Once the polymerization reaction is complete, the Isopar™ G and virtually all the water are removed by vacuum distillation.

f) After introduction of 5% of Montanox™ 20, an anionic thickening inverse latex is obtained which comprises approximately 63% of polymer. The product obtained is not very viscous, it has a high thickening power and it readily becomes inverted. Its water content, measured by Karl-Fischer titrimetry, is 3% by weight.

Viscosity measurements (Brookfield RVT viscometer)

| | Spindle (S); Speed of | |
|---|---|---|
| | rotation of the | |
| | spindle (SR) (in | |
| | revolutions per | Viscosity in |
| | minute) | mPa · s |
| Inverse latex | S 4; SR: 20 | 4000 |
| 2% by weight | S 6; SR: 5 | 135 000 |
| aqueous solution | | |
| 2% by weight | S 6; SR: 5 | 20 800 |
| aqueous solution + | | |
| 0.1% by weight | | |
| of NaCl | | |

### EXAMPLE 3

### Inverse Latex of the AM/AA Copolymer (Molar Ratio: 25/75) (Anionic Thickener—Composition 3)

a) The following are successively introduced, with stirring, into a first beaker:
106.5 g of a commercial 50% (by weight) acrylamide (AM) solution
162.0 g of glacial acrylic acid (AA)
98.1 g of a 29.3% by weight aqueous ammonia solution
277 g of methylenebis(acrylamide) (MBA)
0.45 g of a commercial 40% sodium diethylene-triaminepentaacetate solution
deionized water, up to 680 g

b) An organic phase is prepared in a second beaker by mixing:
121 g of Marcol™ 52
99 g of Isopar™ G
17 g of Montane™ 70
3 kg of Hypermer™ 2296
5 g of Simaline™ IE 200
0.1 g of AIBN

c) The aqueous phase is then introduced into the organic phase with stirring and then the pre-emulsion thus obtained is subjected to vigorous mechanical stirring using a turbine mixer of Silverson type so as to create a fine emulsion while sparging with nitrogen.

d) After cooling to approximately 8° C., the polymerization reaction is initiated using the oxidation/reduction couple: cumene hydroperoxide/sodium metabisulfite.

e) Once the polymerization reaction is complete, the Isopar™ G and virtually all the water are removed by vacuum distillation.

f) After introduction of 5% of Montanox™ 20, an anionic thickening inverse latex is obtained which comprises approximately 63% of polymer. The product obtained is not very viscous, it has a high thickening power and it readily becomes inverted. Its water content, measured by Karl-Fischer titrimetry, is 2.5% by weight.

Viscosity Measurements (Brookfield RVT Viscometer)

A The viscosities of an aqueous solution comprising 2% by weight of the concentrated inverse latex obtained and of an aqueous solution comprising 2% by weight of said inverse latex and 0.1% by weight of sodium chloride are measured.

| | Spindle (S); Speed of | |
|---|---|---|
| | rotation of the | |
| | spindle (SR) (in | |
| | revolutions per | Viscosity in |
| | minute) | mPa · s |
| Inverse latex | S 4; SR: 20 | 400 |
| 2% by weight | S 6; SR: 5 | 150 000 |
| aqueous solution | | |
| 2% by weight | S 6; SR: 5 | 72 800 |
| aqueous solution + | | |
| 0.1% by weight | | |
| of NaCl | | |

B a nonconcentrated inverse latex is prepared by carrying out stages a) to d) of the process described in the present example with the same amounts of products.

On conclusion of stage d), 5% of Montanox™ 20 is added and an inverse latex (Composition III) is obtained which comprises 28% of polymer.

The viscosity of the following solutions is measured:
Composition T at 2% in water: Solution S₁
2% Composition T+0.1% by weight of NaCl: S₂
Composition 3 at 1% in water: Solution S3
Composition 3 at 1% in water +0.1% by weight of NaCl:
Solution S₄

The following results are obtained:

| | Spindle (S); Speed of | |
|---|---|---|
| | rotation of the | |
| | spindle (SR) (in | |
| | revolutions per | Viscosity in |
| | minute) | mPa · s |
| S₁ (state of the | S 6; SR: 5 | 47 800 |
| art) | | |
| S₃ (invention) | S 6; SR: 5 | 55 400 |
| S₂ (state of the | S 3; SR: 5 | 560 |
| art) | | |
| S₄ (invention) | S 3; SR: 5 | 1400 |

The comparison of the results of the salt-comprising solutions (S₂) and (S₄) reveals that the concentrated inverse latex behaves better towards salts than the inverse latex of the state of the art at an equivalent concentration of polymer.

### EXAMPLE 4

### Inverse Latex of the AM/ATBS/AA Terpolymer (Molar Ratio: 65/30/) (Anionic Thickener—Composition 4)

a) The following are successively introduced, with stirring, into a first reactor:
227.5 kg of a commercial 50% (by weight) acrylamide (AM) solution
308.1 kg of a commercial solution comprising 55% of the sodium salt of 2-acrylamido-2-methyl-propanesulfonic acid (ATBS)
8.8 kg of acrylic acid (AA)
0.066 kg of methylenebis(acrylamide) (MBA)
0.37 kg of a commercial 40% sodium diethylene-triaminepentaacetate solution
the pH is adjusted to 6.2 using sodium hydroxide
deionized water, so as to bring the total weight to 564.3 kg.

b) An organic phase is prepared in a second reactor by mixing:
107.6 kg of polyisobutene
74.5 kg of Isopar™ G
14.1 kg of Montane™ 70
2.5 kg of Hypermer™ 2296
4.1 kg of Simaline™ IE200

c) The aqueous phase is then introduced into the organic phase with stirring and then the pre-emulsion thus obtained is subjected to vigorous mechanical stirring using a turbine mixer of Silverson type so as to create a fine emulsion while sparging with nitrogen.

d) After cooling to approximately 8° C., the polymerization reaction is initiated using the oxidation/reduction couple: ammonium persulfate/sodium metabisulfite.

e) Once the polymerization reaction is complete, the Isopar™ G and virtually all the water are removed by vacuum distillation.

f) After introduction of 5% of Montanox™ 20, an anionic thickening inverse latex is obtained which comprises approximately 63% of polymer. The product obtained is not very viscous, it has a high thickening power and it readily becomes inverted. Its water content, measured by Karl-Fischer titrimetry, is 3% by weight.

Viscosity measurements (Brookfield RVT viscometer)

| | Spindle (S); Speed of | |
|---|---|---|
| | rotation of the | |
| | spindle (SR) (in | |
| | revolutions per | Viscosity in |
| | minute) | mPa · s |
| Inverse latex | S 4; SR: 20 | 4000 |
| 2% by weight | S 6; SR: 5 | 90 000 |
| aqueous solution | | |
| 2% by weight | S 6; SR: 5 | 20 000 |
| aqueous solution + | | |
| 0.1% by weight | | |
| of NaCl | | |

### EXAMPLE 5

### Inverse Latex of the AM/ATBS/VP Terpolymer (Molar Ratio: 65/25/10) (Anionic Thickener—Composition 5)

a) The following are successively introduced, with stirring, into a first beaker:
245.6 g of a commercial 50% (by weight) acrylamide (AM) solution
279 g of a commercial solution comprising 55% of the sodium salt of 2-acrylamido-2-methyl-propanesulfonic acid (AMPS)
29.6 g of vinylpyrrolidone (VP)
0.082 g of methylenebis(acrylamide) (MBA)
0.45 g of a commercial 40% sodium diethylene-triaminepentaacetate solution
the pH is adjusted to 5.0 using powdered 2-acrylamido-2-methylpropanesulfonic acid
deionized water, so as to bring the total weight to 644.7 g.

b) An organic phase is prepared in a second beaker by mixing:
110 g of polyisobutene
133 g of Isopar™ G
13.5 g of Montane™ 70
6.5 g of Montanox™ 71
3.0 g of Hypermer™ 2296
5.0 g of Simaline™ IE 200

c) The aqueous phase is then introduced into the organic phase with stirring and then the pre-emulsion thus obtained is subjected to vigorous mechanical stirring using a turbine mixer of Silverson type so as to create a fine emulsion while sparging with nitrogen.

d) After cooling to approximately 8° C., the polymerization reaction is initiated using the oxidation/reduction couple: ammonium persulfate/sodium metabisulfite.

e) Once the polymerization reaction is complete, the Isopar™ G and virtually all the water are removed by vacuum distillation.

f) After introduction of 5% of Montanox™ 20, an anionic thickening inverse latex is obtained which comprises approximately 63% of polymer. The product obtained is not very viscous, it has a high thickening power and it readily becomes inverted. Its water content, measured by Karl-Fischer titrimetry, is 4% by weight.

Viscosity measurements (Brookfield RVT viscometer)

| | Spindle (S); Speed of | |
|---|---|---|
| | rotation of the | |
| | spindle (SR) (in | |
| | revolutions per | Viscosity in |
| | minute) | mPa · s |
| Inverse latex | S 4; SR: 20 | 4000 |
| 2% by weight | S 6; SR: 5 | 75 000 |
| aqueous solution | | |
| 2% by weight | S 6; SR: 5 | 10 000 |
| aqueous solution + | | |
| 0.1% by weight | | |
| of NaCl | | |

### EXAMPLE 6

### Inverse Latex of the AM/APTAC Copolymer (Molar Ratio: 85/15) (Cationic Thickener—Composition)

a) The following are successively introduced, with stirring, into a first beaker:
452.6 g of a commercial 50% (by weight) acrylamide (AM) solution
154.9 g of a commercial 75% N,N,N-trimethyl-3-(1-oxo-2-propenyl)propanammonium chloride (APTAC) solution
0.029 g of methylenebis(acrylamide)
0.56 g of a commercial 40% sodium diethylene-triaminepentaacetate solution
the pH is adjusted to 5.0
the total amount is adjusted to 814 g by addition of the remaining water.

b) An organic phase is prepared in a second beaker by mixing:
137.5 g of Marcol™ 52
186.5 g of Isopar™ G
25.1 g of Montane™ 70 (sorbitan isostearate)
6.3 g of Hypermer™ 2296
6.3 g of ethoxylated lauryl acrylate comprising 4 mol (Blemmer™ ALE 200)
0.123 g of azobis(isobutyronitrile)

c) The aqueous phase is then introduced into the organic phase with stirring and then the pre-emulsion thus obtained is subjected to vigorous mechanical stirring using a turbine mixer of Silverson type so as to create a fine emulsion. The combined mixture is also placed under nitrogen sparging.

d) The polymerization is then initiated using the oxidizing system; cumene hydroperoxide and ammonium persulfate, and reducing system; sodium metabisulfite.

e) Once the polymerization reaction is complete, the Isopar™ G and virtually all the water are removed by vacuum distillation.

f) 5% of Montanox™ 20 is added, so as to render the latex self-invertible.

The product obtained is not very viscous, it readily becomes inverted and it has a high thickening power. Its water content, measured by Karl-Fischer titrimetry, is 3% by weight.

Viscosity measurements (Brookfield RVT viscometer)

| | Spindle (S); Speed of | |
|---|---|---|
| | rotation of the | |
| | spindle (SR) (in | |
| | revolutions per | Viscosity in |
| | minute) | mPa · s |
| Inverse latex | S 4; SR: 20 | 1300 |
| 2% by weight | S 6; SR: 5 | 80 600 |
| aqueous solution | | |
| 2% by weight | S 6; SR: 5 | 13 000 |
| aqueous solution + | | |
| 0.1% by weight | | |
| of NaCl | | |

### Examples of Cosmetic Formulations

### EXAMPLE 7

### Care Cream

| | |
|---|---|
| Cyclomethicone: | 10% |
| Compound of example 2: | 0.8% |
| Montanov ™ 68: | 4.5% |
| Preservative: | 0.65% |
| Lysine: | 0.025% |
| EDTA (disodium salt): | 0.05% |
| Xanthan gum: | 0.2% |
| Glycerol: | 3% |
| Water: | q.s. for 100% |

### EXAMPLE 8

### Care Cream

| | |
|---|---|
| Cyclomethicone: | 10% |
| Compound of example 4: | 0.8% |
| Montanov ™ 68: | 4.5% |
| Perfluoropolymethylisopropyl ether: | 0.5% |
| Preservative: | 0.65% |
| Lysine: | 0.025% |
| EDTA (disodium salt): | 0.05% |
| Pemulen ™ TR: | 0.2% |
| Glycerol: | 3% |
| Water: | q.s. for 100% |

### EXAMPLE 9

### Aftershave Balm

FORMULA

| | | |
|---|---|---|
| A | Composition of example 3: | 1.5% |
| | Water: | q.s. for 100% |
| B | Micropearl ™ M 100: | 5.0% |
| | Sepicide ™ CI: | 0.50% |
| | Fragrance: | 0.20% |
| | 95° Ethanol: | 10.0% |

Procedure
B is added to A.

### EXAMPLE 10

### Satin Emulsion for the Body

FORMULA

| | | |
|---|---|---|
| A | Simulsol ™ 165: | 5.0% |
| | Lanol ™ 1688: | 8.50% |
| | Shea butter: | 2% |
| | Liquid paraffin: | 6.5% |
| | Lanol ™ 14M: | 3% |
| | Lanol ™ S: | 0.6% |
| B | Water: | 66.2% |
| C | Micropearl ™ M 100: | 5% |
| D | Compound of example 5: | 3% |
| E | Sepicide ™ CI: | 0.3% |
| | Sepicide ™ HB: | 0.5% |
| | Monteine ™ CA: | 1% |
| | Fragrance: | 0.20% |
| | Vitamin E acetate: | 0.20% |
| | Sodium pyrrolidinonecarboxylate: | 1% |
| | | (moisturizing agent) |

Procedure

C is added to B, B is emulsified in A at 70° C., D is then added at 60° C. and then E is added at 30° C.

### EXAMPLE 11

### Body Milk

FORMULA

| | | |
|---|---|---|
| A | Simulsol ™ 165: | 5.0% |
| | Lanol ™ 1688: | 12.0% |
| | Lanol ™ 14 M: | 2.0% |
| | Cetyl alcohol: | 0.3% |
| | Schercemol ™ OP: | 3% |
| B | Water: | q.s. for 100% |
| C | Compound of example 4: | 0.35% |
| D | Sepicide ™ CI: | 0.2% |
| | Sepicide ™ HB: | 0.5% |
| | Fragrance: | 0.20% |

Procedure

B is emulsified in A at approximately 75° C., C is added at approximately 60° C. and then D is added at approximately 30° C.

### EXAMPLE 12

### O/W Cream

FORMULA

| | | |
|---|---|---|
| A | Simulsol ™ 165: | 5.0% |
| | Lanol ™ 1688: | 20.0% |
| | Lanol ™ P: | 1.0% |
| B | Water: | q.s. for 100% |
| C | Compound of example 2: | 2.50% |
| D | Sepicide ™ CI: | 0.20% |
| | Sepicide ™ HB: | 0.30% |

Procedure

B is introduced into A at approximately 75° C., C is added at approximately 60° C. and then D is added at approximately 45° C.

### EXAMPLE 13

### Non-greasy Antisun Gel

FORMULA

| | | |
|---|---|---|
| A | Compound of example 5: | 3.00% |
| | Water: | 30% |
| B | Sepicide ™ CI: | 0.20% |
| | Sepicide ™ HB: | 0.30% |
| | Fragrance: | 0.10% |
| C | Colorant: | q.s. |
| | Water: | 30% |
| D | Micropearl ™ M 100: | 3.00% |
| | Water: | q.s. for 100% |
| E | Silicone oil: | 2.0% |
| | Parsol ™ MCX: | 5.00% |

Procedure

B is introduced into A, C is added, then D is added and then E is added.

### EXAMPLE 14

### Antisun Milk

FORMULA

| | | |
|---|---|---|
| A | Sepiperl ™ N: | 3.0% |
| | Sesame oil: | 5.0% |
| | Parsol ™ MCX: | 5.0% |
| | λ-Carrageenan: | 0.10% |
| B | Water: | q.s. for 100% |
| C | Compound of example 3: | 0.80% |
| D | Fragrance: | q.s. |
| | Preservative: | q.s. |

Procedure

B is emulsified in A at 75° C., then C is added at approximately 60° C., then D is added at approximately 30° C. and the pH is adjusted, if necessary.

### EXAMPLE 15

### Massage Gel

FORMULA

| | | |
|---|---|---|
| A | Compound of example 2: | 3.5% |
| | Water: | 20.0% |
| B | Colorant: | 2 drops/100 g |
| | Water: | q.s. |
| C | Alcohol: | 10% |
| | Menthol: | 0.10% |
| D | Silicone oil: | 5.0% |

Procedure

B is added to A, then C is added to the mixture and then D is added to the mixture.

### EXAMPLE 16

### Massage Care Gel

FORMULA

| | | |
|---|---|---|
| A | Compound of example 3: | 3.00% |
| | Water: | 30% |
| B | Sepicide ™ CI: | 0.20% |
| | Sepicide ™ HB: | 0.30% |
| | Fragrance: | 0.05% |
| C | Colorant: | q.s. |
| | Water: | q.s. for 100% |
| D | Micropearl ™ SQL: | 5.0% |
| | Lanol ™ 1688: | 2% |

Procedure

A is prepared, B is added, then C is added and then D is added.

### EXAMPLE 17

### Radiance Gel

FORMULA

| | | |
|---|---|---|
| A | Compound from example 4: | 4% |
| | Water: | 30% |
| B | Elastine HPM: | 5.0% |
| C | Micropearl ™ M 100: | 3% |
| | Water: | 5% |
| D | Sepicide ™ CI: | 0.2% |
| | Sepicide ™ HB: | 0.3% |
| | Fragrance: | 0.06% |
| | 50% sodium pyrrolidinonecarboxylate: | 1% |
| | Water: | q.s. for 100% |

Procedure

A is prepared, B is added, then C is added and then D is added.

### EXAMPLE 18

### Body Milk

FORMULA

| | | |
|---|---|---|
| A | Sepiperl ™ N: | 3.0% |
| | Glyceryl triheptonate: | 10.0% |
| B | Water: | q.s. for 100% |
| C | Compound from example 5: | 1.0% |
| D | Fragrance: | q.s. |
| | Preservative: | q.s. |

Procedure

A is melted at approximately 75° C. B is emulsified in A at 75° C., then C is added at approximately 60° C. and then D is added.

### EXAMPLE 19

### Make-up-removing Emulsion Comprising Sweet Almond Oil

FORMULA

| | |
|---|---|
| Montanov ™ 68: | 5% |
| Sweet almond oil: | 5% |
| Water: | q.s. for 100% |
| Compound of example 4: | 0.3% |
| Glycerol: | 5% |
| Preservative: | 0.2% |
| Fragrance: | 0.3% |

### EXAMPLE 20

### Moisturizing Cream for Greasy Skin

FORMULA

| | |
|---|---|
| Montanov ™ 68: | 5% |
| Cetylstearyl octanoate: | 8% |
| Octyl palmitate: | 2% |
| Water: | q.s. for 100% |
| Compound of example 3: | 0.6% |
| Micropearl ™ M100: | 3.0% |
| Mucopolysaccharides: | 5% |
| Sepicide ™ HB: | 0.8% |
| Fragrance: | 0.3% |

### EXAMPLE 21

### Alcohol-free Soothing Aftershave Balm

FORMULA

| Mixture of lauryl amino acids: | 0.1% to 5% |
|---|---|
| Magnesium potassium aspartate: | 0.002% to 0.5% |
| Lanol ™ 99: | 2% |
| Sweet almond oil: | 0.5% |
| Water: | q.s. for 100% |
| Compound of example 2: | 3% |
| Sepicide ™ HB: | 0.3% |
| Sepicide ™ CI: | 0.2% |
| Fragrance: | 0.4% |

### EXAMPLE 22

### Cream with AHAs for Sensitive Skin

FORMULA

| Mixture of lauryl amino acids: | 0.1% to 5% |
|---|---|
| Magnesium potassium aspartate: | 0.002% to 0.5% |
| Lanol ™ 99: | 2% |
| Montanov ™ 68: | 5.0% |
| Water: | q.s. for 100% |
| Compound of example 2: | 1.50% |
| Gluconic acid: | 1.50% |
| Triethanolamine: | 0.9% |
| Sepicide ™ HB: | 0.3% |
| Sepicide ™ CI: | 0.2% |
| Fragrance: | 0.4% |

### EXAMPLE 23

### Aftersun Soothing Care Preparation

FORMULA

| Mixture of lauryl amino acids: | 0.1% to 5% |
|---|---|
| Magnesium potassium aspartate: | 0.002% to 0.5% |
| Lanol ™ 99: | 10.0% |
| Water: | q.s. for 100% |
| Compound of example 4: | 2.50% |
| Sepicide ™ HB: | 0.3% |
| Sepicide ™ CI: | 0.2% |
| Fragrance: | 0.4% |
| Colorant: | 0.03% |

### EXAMPLE 24

### Make-up-removing Milk

FORMULA

| | |
|---|---|
| Sepiperl ™ N: | 3% |
| Primol ™ 352 | 8.0% |
| Sweet almond oil: | 2% |
| Water: | q.s. for 100% |
| Compound of example 3: | 0.8% |
| Preservative: | 0.2% |

### EXAMPLE 25

### Body Milk

FORMULA

| | |
|---|---|
| Sepiperl ™ N: | 3.5% |
| Lanol ™ 37T: | 8.0% |
| Solagum ™ L: | 0.05% |
| Water: | q.s. for 100% |
| Benzophenone: | 2.0% |
| Dimethicone 350 cPs: | 0.05% |
| Compound of example 5: | 0.8% |
| Preservative: | 0.2% |
| Fragrance: | 0.4% |

### EXAMPLE 26

### Fluid Emulsion with an Alkaline pH

| | |
|---|---|
| Marcol ™ 82: | 5.0% |
| NaOH: | 10.0% |
| Water: | q.s. for 100% |
| Compound of example 2: | 1.5% |

### EXAMPLE 27

### Liquid Foundation

FORMULA

| | |
|---|---|
| Simulsol ™ 165: | 5.0% |
| Lanol ™ 84D: | 8.0% |
| Lanol ™ 99 | 5.0% |
| Water: | q.s. for 100% |
| Inorganic pigments and fillers: | 10.0% |
| Compound of example 3: | 1.2% |
| Preservative: | 0.2% |
| Fragrance: | 0.4% |

### EXAMPLE 28

### Antisun Milk

FORMULA

| | |
|---|---|
| Sepiperl ™ N: | 3.5% |
| Lanol ™ 37T: | 10.0% |
| Parsol ™ NOX: | 5.0% |
| Eusolex ™ 4360: | 2.0% |
| Water: | q.s. for 100% |
| Compound of example 4: | 1.8% |
| Preservative: | 0.2% |
| Fragrance: | 0.4% |

### EXAMPLE 29

### Eye Contour Gel

FORMULA

| | |
|---|---|
| Compound of example 3: | 2.0% |
| Fragrance: | 0.06% |
| Sodium pyrrolidinonecarboxylate: | 0.2% |
| Dow Corning ™ 245 Fluid: | 2.0% |
| Water: | q.s. for 100% |

### EXAMPLE 30

### Leave-on Care Composition

FORMULA

| | |
|---|---|
| Compound of example 4: | 1.5% |
| Fragrance: | q.s. |
| Preservative: | q.s. |
| Dow Corning ™ X2 8360: | 5.0% |
| Dow Corning ™ Q2 1401: | 15.0% |
| Water: | q.s. for 100% |

### EXAMPLE 31

### Slimming Gel

| | |
|---|---|
| Compound of example 5: | 5% |
| Ethanol: | 30% |
| Menthol: | 0.1% |
| Caffeine: | 2.5% |
| Ruscus extract: | 2% |
| Ivy extract: | 2% |
| Sepicide ™ HB: | 1% |
| Water: | q.s. for 100% |

### EXAMPLE 32

### Alcohol-free Soothing Aftershave Balm

FORMULA

| | | |
|---|---|---|
| A | Lipacide ™ PVB: | 1.0% |
| | Lanol ™ 99: | 2.0% |
| | Sweet almond oil: | 0.5% |
| B | Compound of example 3: | 3.5% |
| C | Water: | q.s. for 100% |
| D | Fragrance: | 0.4% |
| | Sepicide ™ HB: | 0.4% |
| | Sepicide ™ CI: | 0.2% |

### EXAMPLE 33

### Aftershave Refreshing Gel

FORMULA

| | | |
|---|---|---|
| A | Lipacide ™ PVB: | 0.5% |
| | Lanol ™ 99: | 5.0% |
| | Compound of example 2: | 2.5% |
| B | Water: | q.s. for 100% |
| C | Micropearl ™ LM: | 0.5% |
| | Fragrance: | 0.2% |
| | Sepicide ™ HB: | 0.3% |
| | Sepicide ™ CI: | 0.2% |

### EXAMPLE 34

### Care Preparation for Greasy Skin

FORMULA

| | | |
|---|---|---|
| A | Micropearl ™ M310: | 1.0% |
| | Compound of example 4: | 5.0% |
| | Octyl isononanoate: | 4.0% |
| B | Water: | q.s. for 100% |
| C | Sepicontrol ™ A5: | 4.0% |
| | Fragrance: | 0.1% |
| | Sepicide ™ HB: | 0.3% |
| | Sepicide ™ CI: | 0.2% |
| D | Capigel ™ 98: | 0.5% |
| | Water: | 10% |

### EXAMPLE 35

### Cream Comprising AHAs

FORMULA

| | | |
|---|---|---|
| A | Montanov ™ 68: | 5.0% |
| | Lipacide ™ PVB: | 1.05% |
| | Lanol ™ 99: | 10.0% |
| B | Water: | q.s. for 100% |
| | Gluconic acid | 1.5% |
| | TEA (triethanolamine): | 0.9% |
| C | Compound of example 5: | 1.5% |
| D | Fragrance: | 0.4% |
| | Sepicide ™ HB: | 0.2% |
| | Sepicide ™ CI: | 0.4% |

### EXAMPLE 36

### Non-greasy Self-tanning Preparation for the Face and Body

FORMULA

| | | |
|---|---|---|
| A | Lanol ™ 2681: | 3.0% |
| | Compound of example 4: | 2.5% |
| B | Water: | q.s. for 100% |
| | Dihydroxyacetone: | 3.0% |
| C | Fragrance: | 0.2% |
| | Sepicide ™ HB: | 0.8% |
| | Sodium hydroxide: | q.s. pH = 5 |

### EXAMPLE 37

### Antisun Milk Comprising Tahitian Perfumed Oil

FORMULA

| | | |
|---|---|---|
| A | Tahitian perfumed oil | 10% |
| | Lipacide ™ PVB: | 0.5% |
| | Compound of example 2: | 2.2% |
| B | Water: | q.s. for 100% |
| C | Fragrance: | 0.1% |
| | Sepicide ™ HB: | 0.3% |
| | Sepicide ™ CI: | 0.1% |
| | Octyl methoxycinnamate: | 4.0% |

### EXAMPLE 38

### Antisun Care Preparation for the Face

FORMULA

| | | |
|---|---|---|
| A | Cyclomethicone and dimethiconol: | 4.0% |
| | Compound of example 3: | 3.5% |
| B | Water: | q.s. for 100% |
| C | Fragrance: | 0.1% |
| | Sepicide ™ HB: | 0.3% |
| | Sepicide ™ CI: | 0.21% |
| | Octyl methoxycinnamate: | 5.0% |
| | Titanium oxide-coated mica | 2.0% |
| | Lactic acid: | q.s. for pH = 6.5 |

### EXAMPLE 39

### Sunless Tanning Emulsion

FORMULA

| | | |
|---|---|---|
| A | Lanol ™ 99: | 15% |
| | Montanov ™ 68: | 5.0% |
| | Octyl para-methoxycinnamate: | 3.0% |
| B | Water: | q.s. for 100% |
| | Dihydroxyacetone: | 5.0% |
| | Monosodium phosphate: | 0.2% |
| C | Compound of example 4: | 0.5% |
| D | Fragrance: | 0.3% |
| | Sepicide ™ HB: | 0.8% |
| | Sodium hydroxide: | q.s. for pH = 5. |

### EXAMPLE 40

### Sheen Gel

| | |
|---|---|
| Compound of example 5: | 1.5% |
| Volatile silicone: | 25% |
| Monopropylene glycol: | 25% |
| Demineralized water: | 10% |
| Glycerol: | q.s. for 100% |

### EXAMPLE 41

### Slimming Gel

| | |
|---|---|
| Compound of example 4: | 1.5% |
| Isononyl isononanoate: | 2% |
| Caffeine: | 5% |
| Ethanol: | 40% |
| Micropearl ™ LM: | 2% |
| Demineralized water: | q.s. for 100% |
| Preservative, fragrance: | q.s. |

### EXAMPLE 42

### Make-up-removing Milk

| | |
|---|---|
| Simulsol ™ 165: | 4% |
| Montanov ™ 202: | 1% |
| Caprylate/caprate triglyceride: | 15% |
| Pecosil ™ DCT: | 1% |
| Demineralized water: | q.s. |
| Capigel ™ 98: | 0.5% |
| Compound of example 5 | 1% |
| Proteol ™ OAT: | 2% |
| Sodium hydroxide: | q.s. for pH = 7 |

### EXAMPLE 43

### Restructuring Rinse-off Cream Mask for Stressed and Embrittled Hair

FORMULA

| | |
|---|---|
| Ketrol ™ T: | 0.5% |
| Pecosil ™ SPP50: | 0.75% |
| N-Cocoyl amino acids | 0.70% |
| Butylene glycol: | 3.0% |
| Compound of example 1: | 3.0% |
| Montanov ™ 82: | 3.0% |
| Jojoba oil: | 1.0% |
| Lanol ™ P: | 6.0% |
| Amonyl ™ DM: | 1.0% |
| Lanol ™ 99: | 5.0% |
| Sepicide ™ HB: | 0.3% |
| Sepicide ™ CI: | 0.2% |
| Fragrance: | 0.2% |
| Water | q.s. for 100% |

### EXAMPLE 44

### Antisun Cream

| | |
|---|---|
| Simulsol ™ 165: | 3% |
| Montanov ™ 202: | 2% |
| C₁₂-C₁₅ benzoate: | 8% |
| Pecosil ™ PS 100: | 2% |
| Dimethicone: | 2% |
| Cyclomethicone: | 5% |
| Octyl para-methoxycinnamate: | 6% |
| Benzophenone-3: | 4% |
| Titanium oxide | 8% |
| Xanthan gum: | 0.2% |
| Butylene glycol: | 5% |
| Demineralized water: | q.s. for 100% |
| Compound of example 2: | 1.5% |
| Preservative, fragrance: | q.s. |

### EXAMPLE 45

### Care Gel for Combination Skin

| | |
|---|---|
| Compound of example 3: | 4% |
| Vegetable squalane: | 5% |
| Dimethicone: | 1.5% |
| Sepicontrol ™ A5: | 4% |
| Xanthan gum: | 0.3% |
| Water: | q.s. for 100% |
| Preservative, fragrance: | |

### EXAMPLE 46

### Hair Lotion

FORMULA

| | |
|---|---|
| Butylene glycol: | 3.0% |
| Compound of example 6: | 3% |
| Simulsol ™ 1293: | 3.0% |
| Lactic acid: | q.s. for pH = 6 |
| Sepicide ™ HB: | 0.2% |
| Sepicide ™ CI: | 0.3% |
| Fragrance: | 0.3% |
| Water: | q.s. 100% |

### EXAMPLE 47

### Protecting and Relaxing Shampoo

FORMULA

| | |
|---|---|
| Amonyl ™ 675 SB: | 5.0% |
| 28% Sodium lauryl ether sulfate: | 35.0% |
| Composition of example 6: | 3.0% |
| Sepicide ™ HB: | 0.5% |
| Sepicide ™ CI: | 0.3% |
| Sodium hydroxide: | q.s. pH = 7.2 |
| Fragrance: | 0.3% |
| Colorant (FDC Blue 1/Yellow 5): | q.s. |
| Water: | q.s. for 100% |

### EXAMPLE 48

### Leave-on Protecting Preparation; Hair Care Preparation for Combating Stress

FORMULA

| | |
|---|---|
| Ketrol ™ T: | 0.5% |
| Mixture of cocoyl amino acids: | 3.0% |
| Butylene glycol: | 5.0% |
| DC 1501: | 5.0% |
| Composition of example 1: | 4.0% |
| Sepicide ™ HB: | 0.5% |
| Sepicide ™ CI: | 0.3% |
| Fragrance: | 0.3% |
| Water: | q.s. for 100% |

### EXAMPLE 49

### Vitamin Cream

| | |
|---|---|
| Simulsol ™ 165: | 5% |
| Montanov ™ 202: | 1% |
| Caprylic/capric triglycerides: | 20% |
| Vitamin A palmitate: | 0.2% |
| Vitamin E acetate: | 1% |
| Micropearl ™ M 305 | 1.5% |
| Compound of example 1: | 2% |
| Water | q.s. for 100% |
| Preservative, fragrance | q.s. |

The definitions of the commercial products used in the examples are as follows:
Simulsol™ 1293 is hydrogenated and ethoxylated castor oil with an ethoxylation number of 40, sold by Seppic.
Capigel™ 98 is a liquid thickener based on acrylate copolymer sold by Seppic.
Ketrol™ 99 is xanthan gum, sold by Kelco.
Lanol™ 99 is isononyl isononanoate, sold by Seppic.
DC1501 is a mixture of cyclopentasiloxane and dimethiconol sold by Dow Chemical.
Montanov™ 82 is an emulsifying agent based on cetearyl alcohol and on cocoyl glucoside.
Montanov™ 68 (cetearyl glucoside) is a self-emulsifiable composition, such as disclosed in WO 92/06778, sold by Seppic.
Micropearl™ M 100 is an ultrafine powder with a very soft feel and with a mattifying action, sold by Matsumo.
Sepicide™ CI, imidazolidineurea, is a preservative sold by Seppic.
Pemulen™ TR is an acrylic polymer sold by Goodrich.
Simulsol™ 165 is self-emulsifiable glyceryl stearate, sold by Seppic.
Lanol™ 1688 is an emollient ester with a non-greasy effect sold by Seppic.
Lanol™ 14M and Lanol™ S are consistency factors sold by Seppic.
Sepicide™ HB, which is a mixture of phenoxyethanol, methylparaben, ethylparaben, propylparaben and butyl-paraben, is a preservative sold by Seppic.
Monteine™ CA is a moisturizing agent sold by Seppic.
Schercemol™ OP is an emollient ester with a non-greasy effect.
Lanol™ P is an additive with a stabilizing effect sold by Seppic.
Parsol™ MCX is octyl para-methoxycinnamate, sold by Givaudan.
Sepiperl™ N is a pearlescent agent, sold by Seppic, based on a mixture of alkyl polyglucosides such as those disclosed in WO 95/13863.
Micropearl™ SQL is a mixture of microparticles including squalane which is released under the action of massaging; it is sold by Matsumo.
Lanol™ 99 is isononyl isononanoate, sold by Seppic.
Lanol™ 37T is glyceryl triheptanoate, sold by Seppic.
Solagum™ L is a carrageenan sold by Seppic.
Marcol™ 82 is a liquid paraffin sold by Exxon.
Lanol™ 84D is dioctyl malate, sold by Seppic.
Parsol™ NOX is a sunscreen sold by Givaudan.
Eusolex™ 4360 is a sunscreen sold by Merck.
Dow Corning™ 245 Fluid is cyclomethicone, sold by Dow Corning.
Lipacide™ PVB is a hydrolyzate of acylated wheat proteins sold by Seppic.
Micropearl™ LM is a mixture of squalane, poly(methyl methacrylate) and menthol sold by Seppic.
Sepicontrol™ A5 is a capryloylglycine, sarcosine, extract of Cinnamon zylanicum mixture sold by Seppic, such as those disclosed in international patent application PCT/FR98/01313 filed on 23 Jun. 1998.
Lanol™ 2681 is a coconut caprylate/caprate mixture sold by Seppic.
Montanov™ 202 is an APG/fatty alcohols composition as disclosed in WO 98/47610, sold by Seppic.

1-15. (canceled)

16. A composition in the form of an inverse latex comprising:
a) from 50% by weight to 80% by weight of at least one linear, branched or crosslinked organic polymer (P);
b) from 5% by weight to 10% by weight of an emulsifying system (S₁) of water-in-oil (W/O) type;
c) from 5% by weight to 45% by weight of at least one oil; and
d) from 0% to 5% by weight of water.

17. The composition of claim 16, in which the polymer (P) is:
a) either a homopolymer of a monomer chosen either from those having a partially or completely salified strong acid functional group or from those having a partially or completely salified weak acid functional group or from cationic monomers;
b) or a copolymer in which each of the monomers is chosen, independently of one another, either from those having a partially or completely salified strong acid functional group or from those having a partially or completely salified weak acid functional group or from neutral monomers or from cationic monomers;
c) or a terpolymer in which each of the monomers is chosen, independently of one another, either from those having a partially or completely salified strong acid functional group or from those having a partially or completely salified weak acid functional group or from neutral monomers or from cationic monomers; and
d) or a tetrapolymer in which each of the monomers is chosen, independently of one another, either from those having a partially or. completely salified strong acid functional group or from those having a partially or completely salified weak acid functional group or from neutral monomers or from cationic monomers.

18. The composition of claim 16, in which the polymer (P) is crosslinked with a diethylene or polyethylene compound in the molar proportion, expressed with respect to the monomers employed, of 0.005% to 1%, preferably of 0.01% to 0.2% and more particularly of 0.01% to 0.1%.

19. The composition of claim 18, for which the crosslinking agent and/or the branching agent is chosen from ethylene glycol dimethacrylate, diethylene glycol diacrylate, sodium diallyloxyacetate, ethylene glycol diacrylate, diallylurea, triallylamine, trimethylolpropane triacrylate or methylenebis(acrylamide).

20. The composition of claim 16, for which the monomer possessing a strong acid functional group which the polymer (P) comprises is partially or completely salified 2-methyl-2-[(1-oxo-2-propenyl)amino]-1-propanesulfonic acid.

21. The composition of claim 16, for which the monomers possessing a weak acid functional group which the polymer (P) comprises are chosen from partially or completely salified acrylic acid, methacrylic acid, itaconic acid, maleic acid or 3-methyl-3-[(1-oxo-2-propenyl)amino]butanoic acid.

22. The composition of claim 16, for which the monomers possessing a weak acid functional group which the polymer (P) comprises are chosen from acrylamide, methacrylamide, diacetone acrylamide, dimethylacrylamide, N-isopropylacrylamide, N-[2-hydroxy-1,1-bis(hydroxymethyl)ethyl]propenamide, 2-hydroxyethyl acrylate, 2,3-dihydroxypropyl acrylate, 2-hydroxyethyl methacrylate, 2,3-dihydroxypropyl methacrylate, an ethoxylated derivative with a molecular weight of between 400 and 1000 of each of these esters, or vinylpyrrolidone.

23. The composition of claim 16, for which the cationic monomers which the polymer (P) comprises are chosen from 2,N,N,N-tetramethyl-2-[(1-oxo-2-propenyl)amino]propanammonium, 2, N,N-tri-methyl-2-[(1-oxo-2-propenyl)amino]propanammonium, N,N,N-trimethyl-2-[(1-oxo-2-propenyl)oxy]ethanammonium, N,N,N-trimethyl-3-[(1-oxo-2-propenyl)oxy]propanammonium, N,N,N-trimethyl-2-[(1-oxo-2-propenyl)amino]propanammonium or diallyldimethylammonium salts.

24. The composition of claim 16, in which the polymer (P) is chosen from:
a) crosslinked copolymers of acrylic acid, partially salified in the sodium salt or ammonium salt form, and of acrylamide;
b) crosslinked copolymers of 2-methyl-2-[(1-oxo-2-propenyl)amino]-1-propanesulfonic acid, partially salified in the sodium salt form, and of acrylamide;
c) crosslinked copolymers of 2-methyl-2-[(1-oxo-2-propenyl)amino]-1-propanesulfonic acid and of acrylic acid, which are partially salified in the sodium salt form;
d) crosslinked copolymers of 2-methyl-2-[(1-oxo-2-propenyl)amino]-1-propanesulfonic acid, partially salified in the sodium salt form, and of 2-hydroxyethyl acrylate;
e) crosslinked copolymers of acrylamide and of N,N,N-trimethyl-3-(1-oxo-2-propenyl)propanammonium;
f) crosslinked homopolymers of 2-methyl-2-[(1-oxo-2-propenyl)amino]-1-propanesulfonic acid, partially salified in the sodium salt form;
g) crosslinked homopolymers of acrylic acid, partially salified in the ammonium salt or monoethanolamine salt form;
h) terpolymers of acrylamide, of N,N,N-trimethyl-3-(1-oxo-2-propenyl)propanammonium and of [tris(hydroxy-methyl)aminomethyl]acrylamide;
i) crosslinked terpolymers of acrylamide, of 2-methyl-2-[(1-oxo-2-propenyl)amino]-1-propanesulfonic acid and of acrylic acid, which are partially salified in the sodium salt form; and
j) terpolymers of 2-methyl-2-[(1-oxo-2-propenyl)amino]-1-propanesulfonic acid, partially salified in the sodium salt form, of acrylamide and of vinylpyrrolidone.

25. The composition of claim 16, comprising from 60% by weight to 70% by weight of polymer (P).

26. The composition of claim 16, additionally comprising up to 5% of its weight of an emulsifying system (S₂) of oil-in-water (O/W) type.

27. A process for the preparation of the composition as defined above, characterized in that:
a) an aqueous phase (A) comprising the monomers and the optional hydrophilic additives is emulsified in an organic phase (O) comprising the surfactant system (S₁), a mixture composed of the oil intended to be present in the final composition and of a volatile oil, and the optional hydrophobic additives,
b) the polymerization reaction is initiated by introduction of an initiator of free radicals into the emulsion formed in a) and then the reaction is allowed to take place, and
c) the reaction medium resulting from stage b) is concentrated by distillation until said volatile oil has been completely removed.

28. The process of claim 27, in which, on conclusion of stage c), one or more emulsifying agents of oil-in-water type is/are introduced at a temperature of less than 50° C.

29. The use of the composition of claim 16 as thickener and/or emulsifier for a cosmetic, dermopharmaceutical or pharmaceutical topical composition.

30. The use of the composition of claim 16 as thickener for textile printing pastes.
